(19) United States
(12) Patent Application Publication
(10) Pub. No.: US 2004/0201573 A1
(43) Pub. Date: Oct. 14, 2004

(54) Illuminated computer peripheral

(75) Inventors: Sun Yu, Berkley, MI (US); David A. Perrin, Troy, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: Zen Design Group, Ltd., Berkley, MI

(21) Appl. No.: 10/411,513

(22) Filed: Apr. 10, 2003

(51) Int. Cl. G09G 5/08

(52) U.S. Cl. 345/163

(57) ABSTRACT

A computer peripheral device includes a peripheral housing having a translucent or transparent region. A light source within the housing is positioned to emit light through the translucent or transparent region of the housing. A wire in electrical communication with the light source terminates in a computer interface connector. The computer peripheral device is a mouse, speaker, display frame housing or disc housing.

### FIELD OF THE INVENTION

The present invention relates generally to external computer peripherals and more specifically to an illuminated computer peripheral.

### BACKGROUND OF THE INVENTION

The computer peripheral has become a commonplace computer component. An external computer peripheral is an attractive component owing to the ease of plugging the peripheral into the computer by way of an interface cable that connects to an external computer port. This scheme obviates the need to remove the computer housing cover to interchange devices. With the ever-decreasing size and cost of computers, computer usage has extended from the traditional desktop setting. It is now commonplace to operate a computer under low ambient light conditions experienced in a darkened airplane, outdoors, in presentations, laboratory facilities, and sleeping quarters. Illuminated keyboards are common in cockpit controls and laser facilities. An illuminated keyboard addresses the need to enter computer data under low light conditions yet does little to help locate a computer peripheral.

A light emitting diode is commonly seen protruding from the housing of such computer peripherals as a monitor and a speaker as an indicator of power activation. The light output from an indicator LED affords minimal illumination to facilitate computer peripheral operation under low light conditions. The optical mouse uses a light emitting diode for the operation of the mouse yet only provides reflective lighting from the mouse base that affords minimal illumination for the operation of the buttons thereon. The optical mouse uses the light emitting diode common optical sensor in a digital signal processor in place of a mouse ball and electromechanical transducer. Movement of the optical mouse is detected by sensing changes in reflected light with changes in reflected light intensity being translated to optical mouse movement. Thus, there exists a need for an illuminated computer peripheral having illumination that facilitates operation thereof.

### SUMMARY OF THE INVENTION

A computer peripheral device includes a peripheral housing having a translucent or transparent region. A light source within the housing is positioned to emit light through the translucent or transparent region of the housing. A wire in electrical communication with the light source terminates in a computer interface connector. The computer peripheral device is a mouse, a light, speaker, display frame housing or disc housing.

In another embodiment, a computer peripheral device includes light emitting diodes as a light source. The emissions from the light emitting diodes project through a translucent or transparent region of a device housing. A regulation subcircuit functions to drive the light emitting diodes. Where the light emitting diode has a variable color output, the diode is driven to maintain a uniform output color, a uniform flux or vary flux of each diode component to effectively vary output color as a function of time. A wire in electrical communication with the subcircuit terminates in a universal serial bus connector. The computer peripheral is a mouse, a light, speaker, display frame housing, or disc housing.

### BRIEF DESCRIPTION OF THE DRAWINGS

FIG. 1 is an exploded perspective view of an inventive embodiment incorporated into a computer mouse;

FIG. 2 is a partial cutaway perspective view of another inventive embodiment incorporated into a computer display;

FIG. 3 is a partial cutaway perspective view of an inventive embodiment incorporated into a computer light;

FIG. 4 is a cross-sectional view of a housing containing the computer light of FIG. 3;

FIG. 5 is a perspective view of the housing of FIG. 4 in an open position;

FIG. 6 is a schematic of a first play pattern for an inventive computer light having two fixed emission LEDs;

FIG. 7 is a schematic of an alternate play pattern for an inventive computer light having a fixed emission and red-green-blue (RGB) LEDs;

FIG. 8 is a schematic of a second alternate play pattern for an inventive computer light having a fixed emission and RGB LEDs; and

FIG. 9 is a schematic of a third alternate play pattern for an inventive computer light having three fixed emission LEDs that vary in color therebetween.

### DETAILED DESCRIPTION OF THE PREFERRED EMBODIMENTS

The present invention has utility as a computer peripheral operable under low ambient light conditions. In an embodiment of the present invention having variable intensity illumination, a soothing effect is also noted on an operator of the inventive device. A light source, preferably a light emitting diode (LED), is oriented to project illumination in the general direction of an operator through a translucent housing. Modulating light source output provides variable illumination, or in the instance of a multiple color or multiple LEDs, a variation in net illumination color.

A computer peripheral according to the present invention includes those devices amenable to coupling to a computer interface panel by way of an interface connector. A computer peripheral as detailed herein illustratively includes a mouse, a speaker, a display, CD-ROM, CD-R, CD-RW and disc devices such as hard, floppy, DVD, tape, WORM, JAZ, and ZIP. Interface connector types operative with the present invention illustratively include small computer serial interface, parallel, or universal serial bus (USB). It is appreciated that the choice of interface connector is largely dictated by the power requirements of the computer peripheral as well as the light source integrated therein.

An inventive light source illustratively includes an incandescent bulb, a solid state laser, and a light emitting diode. Preferably, the light source is a light emitting diode. The LED emission color illustratively includes red, orange, yellow, green, blue, violet and white.

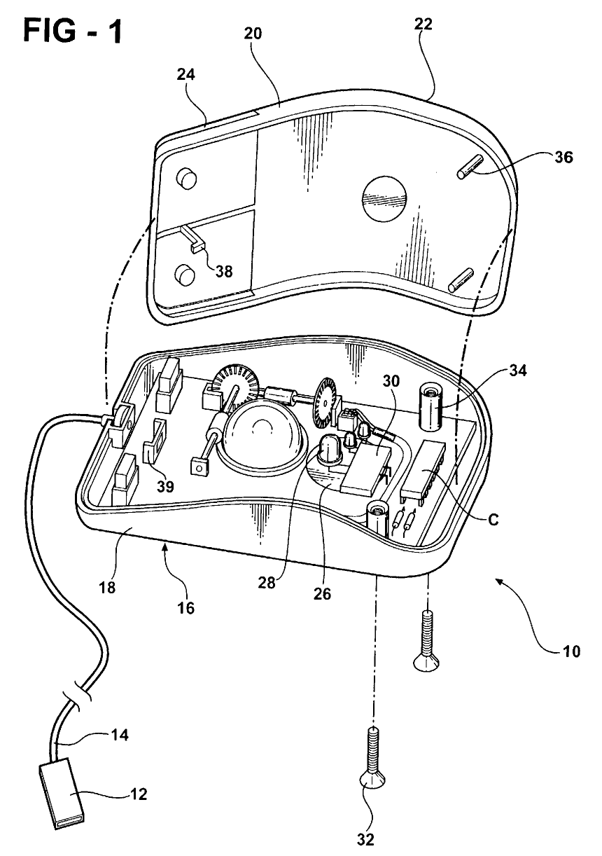

The invention is further described with respect to the following non-limiting embodiments depicted in the drawings. Referring now to FIG. 1, an inventive computer peripheral, in this case a mouse, is depicted generally at 10. A USB computer interface connector 12 is adapted to couple to a computer interface panel (not shown). An insulated wire 14 extends from the USB connector 12 into the peripheral housing 16. The peripheral housing 16 has a bottom housing portion 18 and a complementary upper housing portion 20. The bottom housing portion 18 and upper housing portion 20 are secured with a fastener 32 secured against a through hole 34 in the bottom housing portion 18. The through hole 34 in alignment with a complementary interior threaded post 36 extending from the upper housing portion 20. It is appreciated that peripheral housing portions are secured by other means including a pressure fit post 38 and lock 39 arrangement as depicted in FIG. 1. Alternatively, adhesive, sonic welds or other conventional securement techniques conventional to the art of the particular computer peripheral are operative herein. The upper housing portion 20 has a dome 22 and a keypad portion 24. The upper housing portion 20 has an optically translucent or transparent region. Preferably, the upper housing portion 20 is translucent. As used herein, translucent is defined to mean that light passes therethrough with diffusion such that object features on the light emitting side are obscured. Preferably, the dome 22 of the upper housing portion 20 is translucent. It is appreciated that the upper housing portion 20 is formed of an opaque plastic conventional to the art, such as injection moldable ABS with a translucent region insert secured thereto to form the dome 22 or alternatively, the upper housing portion 20 is formed of a translucent material. While it is appreciated that the keypad portion 24 optionally is translucent, owing to the necessity of underlying support for the keypads and mechanical contacts, light emission to the keypad portion requires additional engineering to assure effective light transmission. It is further appreciated that a reflector 26 located within the peripheral housing 16 serves to redirect light through a translucent portion of the upper housing portion 20. Optionally, other components of the peripheral housing 16, such as the bottom housing portion 18 of the embodiment depicted in FIG. 1, are also readily formed of a translucent plastic material.

The insulated wire 14 is in electrical communication with at least one light source 28. Intermediate between the insulated wire 14 and the light source 28 exists a conventional electrical regulation subcircuit 30. The regulation subcircuit 30 serves to modify input voltage and/or current communicated via the USB connector 12. The regulation subcircuit 30 illustratively includes a voltage step-up circuit, a voltage step-down circuit, and/or a current regulating circuit. The preferred light source 28 is an LED. Most conventional LEDs operate at or below 3.5 volts making the output from a computer interface panel USB port of 4.2 volts particularly well suited for driving this type of light source. It is appreciated that the regulation subcircuit 30 is well suited to be integrated into the layout of electronic and electromechanical components conventional to the computer peripheral and shown in FIG. 1 in ghost at C.

The light source 28 is preferably positioned so that light emission therefrom emanates through the translucent region of upper housing portion 20. In a still more preferred embodiment, the light source 28 includes several light sources. Most preferably, the multiple light sources include at least three light sources, with each of the at least three light sources varying in emissive wavelength. Where the multiple light sources 28 vary in wavelength, the net emission observed through the translucent region of the upper housing portion 20 is dynamically modified by controlling the emission intensity from each of the light sources. By way of example, the light source 28 including a red, a blue, and a yellow LED is capable of simulating a dynamic visible light prismatic effect by sequentially cycling the emission output from each of the red, blue and yellow LEDs with a degree of temporal overlap therebetween. By ramping light source output for a plurality of light sources each having a different wavelength, a color spectrum is dynamically spanned between the maximal emissive output of a first LED, when this is the only LED active, and the minimal emissive output wavelength of a second LED, when this second LED is the only LED active.

In an alternate mode, a multiple-source light source 28 changes emission wavelength upon an operator action such as, for example, activating the computer peripheral through electronic or electromechanical activation of the ghost circuit C. For example, the ready state of the computer peripheral mouse 10 has a red translucence, right clicking converts the translucent emission to blue, translating the mouse triggers a yellow translucent emission and simultaneous right clicking and translation optionally creates a green translucent emission.

In the inventive embodiment where translucent emission is observed through the housing of a speaker (not shown), it is appreciated that the emissive wavelength optionally is coupled to the speaker output frequency. This coupling creates an optical false color display coordinated with speaker output sound.

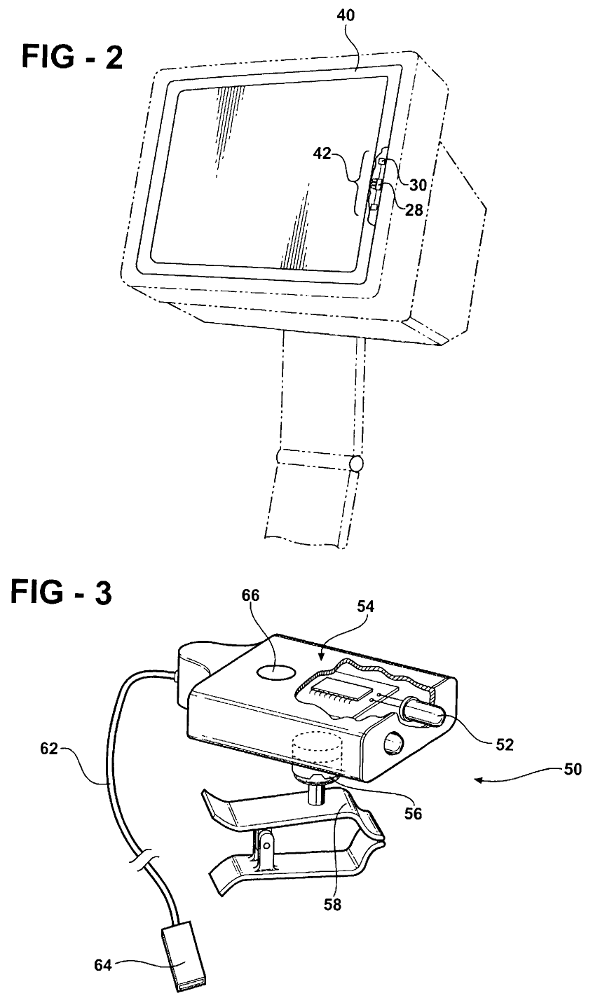

In the embodiment depicted in FIG. 2, a translucent frame 40 surrounds the screen of a conventional display shown in ghost at D. Within the translucent frame 40 is an electrical regulation subcircuit 30 powering a light source 28 where like numbers correspond to those numerals used with respect to FIG. 1. Preferably, the light source 28 is a light emitting diode. Still more preferably, the light source 28 is a plurality of LEDs that vary in predominant emission wavelength. An emission unit including a light source 28 and a regulation subcircuit 30 together form an emission unit 42. A plurality of emission units 42 decorate the translucent frame 40. Preferably, at least one emission unit 42 is on each side of the generally rectilinear frame 40. The plurality of emission units 42 are in electrical communication so that their emissions are synchronized. The modulation of either emission intensity or color in the instance where the light source includes different color emitting sources tends to reduce eyestrain associated with prolonged viewing of the computer display. Through computer software, inventive light emission is modulated with respect to characteristics illustratively including intensity, color, and modulation period.

A translucent plastic portion operative in the present invention is formed by conventional techniques including the addition of an opacifying agent to an otherwise transparent injection moldable plastic at a loading level that permits the transmission of diffused light therethrough. Alternatively, a clear plastic molding is frosted by abrasion or chemical etch.

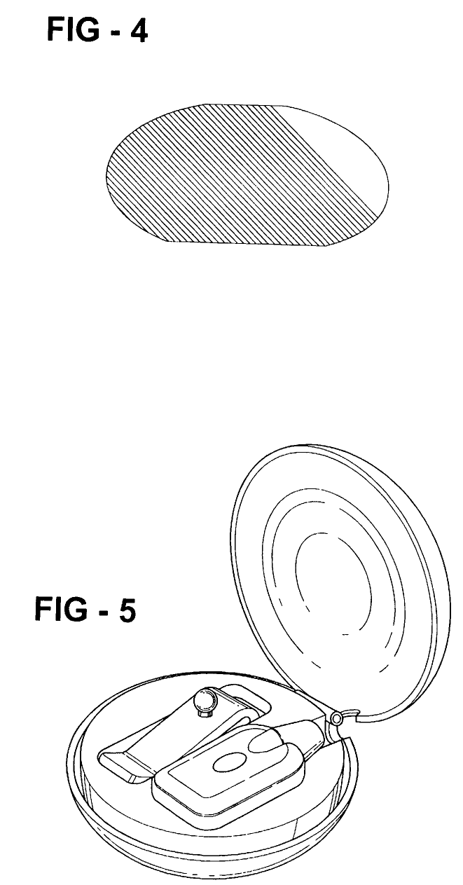

In an alternate embodiment shown in FIGS. 3-5, a computer light is shown generally at 50. The light 50 includes at least one LED 52 within a lamp body 54. The lamp body 54 having a joint fitting 56 thereon, the fitting 56 complementary to a conventional securement 58 adapted to support the light housing 54 proximal to a display of a laptop computer or PDA. Preferably, the securement 58 is a spring loaded clip 210 capable of encompassing the width of an electronic device proximal to a display.

Extending from the lamp body 54 and in electrical communication with the LED 52 is an insulated electric wire 62 that terminates in a computer interface connector 64, illustratively including a small computer serial interface, parallel, or universal serial bus (USB). While it is appreciated that the choice of interface connector is largely dictated by the power requirements of the computer,peripheral as well as the light source integrated therein, preferably the connector 64 is a USB connector. Optionally, a manual switch 66 resides along the length of insulated wire 62 or within the housing 54. Preferably, when a switch 66 is present, the switch is situated within the lamp housing. Preferably, an inventive lamp 50 is stored in a housing 70 including a translucent or transparent cover 72 and a base 74. The base 74 has a contoured interior 76 adapted to receive the lamp housing 54 in an orientation such that the LED 52 is visible through cover 72. A similar contour exists within the body 74 to accommodate the securement 58. The cover 72 has a notch 78 therein allowing the wire 62 to extend from the lamp housing 54 within the housing 70 and extending to the computer interface fitting 64 engaging a compatible port of an electronic device (not shown). This capability allows an inventive lamp 50 to be used in several operational modes. By removing the cover 72, the lamp body 54 is coupled to the securement, while the securement 58 remains within the body of the housing 70. The housing 70 serves as a platform resting on any horizontal surface to provide illumination without securing the inventive lamp body 54 to a computer. In an alternate mode, the housing 70 with the inventive light therein is coupled to a power source such that an LED 52 within the light body 54 is activated with light shining through the transparent or translucent housing cover 72 to create a soft back lighting effect in the area of the housing 70 or to serve as a nightlight. The cover 72 and base 74 components of the housing 70 are formed of materials conventional to the art illustratively including injection moldable thermoplastic.

In a preferred embodiment, an inventive headlamp includes multiple light emitting diodes. Various modes of operation are depicted for exemplary embodiments of the present invention including two LEDs.

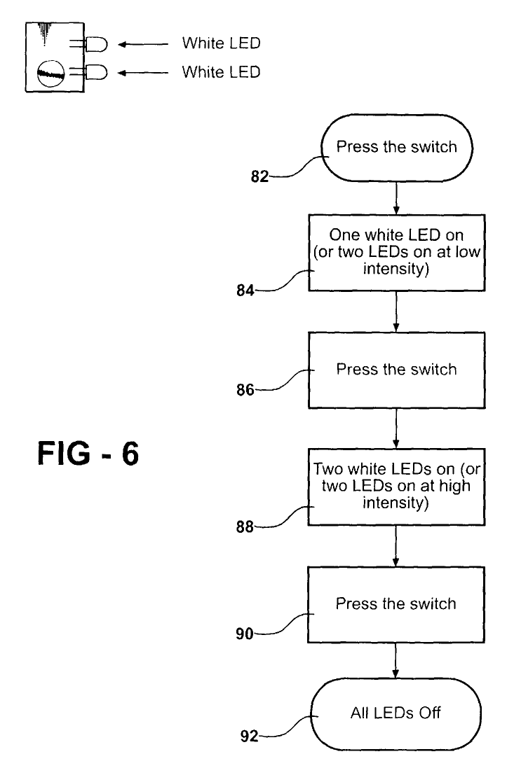

A first play pattern is illustrated in FIG. 6 for an inventive lamp having two like emitting LEDs or banks of LEDs. By way of example, the LEDs are supposed to both be white light emission LEDs. Initial activation of the switch 82 causes the illumination of either one white light LED or alternatively, both LEDs at a low intensity setting 84. A subsequent switch activation 86 induces emission from both white light LEDs or, alternatively, both white light LEDs to emit at high light intensity 88. Thereafter, activation of the switch 90 extinguishes emission from both white light LEDs 92 with further activation of the switch repeating the play pattern.

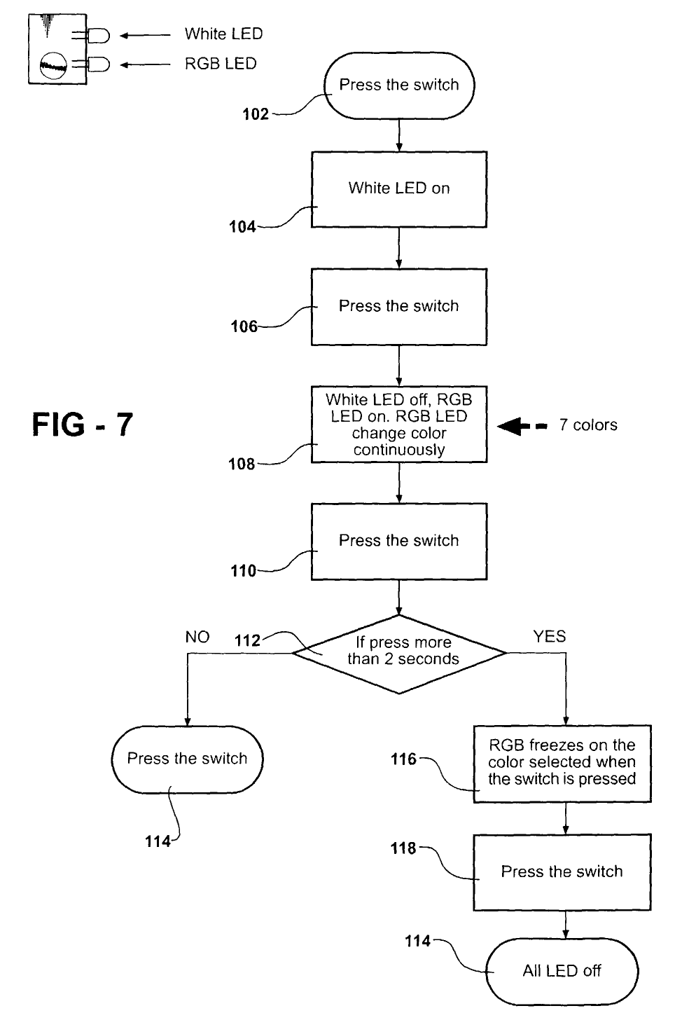

A further play pattern for the present invention is shown schematically in FIG. 7 in which one of the light emitting diodes has a variable color light output, such as a red-green-blue (RGB) light emitting diode. Initial activation of the switch 102 causes the illumination of the uniform wavelength profile LED that is for exemplary purposes detailed in FIG. 7 as a white LED 104. A subsequent activation of the light housing switch 106 extinguishes the white LED and induces RGB LED activation where the RGB LED cycles emission wavelength continuously 108. Thereafter, activation of the switch 110 for less than a predetermined amount of time, such as for instance two seconds, extinguishes both LEDs 114; whereas switch activation 110 for more than the preselected amount of time 112 freezes the RGB LED in an emission color 116, the emission color being that present upon switch activation 110. With an inventive light having a continuous color emission from an LED capable of variable color emission, subsequent activation of the switch 38 extinguishes both LEDs 114.

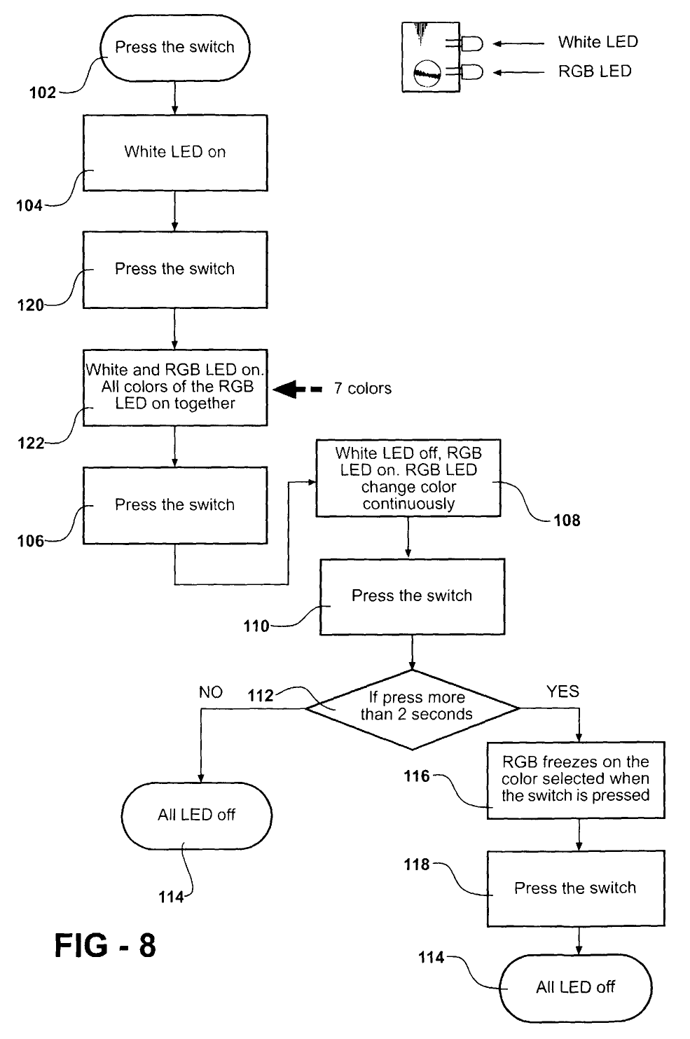

An alternative play pattern to that depicted in FIG. 8 is shown in FIG. 7 where like numerals therebetween denote common actions and outcomes. The play pattern of FIG. 8 has an additional mode following activation of the white LED relative to FIG. 7, initiated by activation of the switch 120 so as to illuminate the white LED 104 and place the RGB LED in a full illumination state with simultaneous RGB emissions to create a white light emission therefrom 122. Subsequent switch activation produces changes in light emission from the inventive device as detailed previously with respect to FIG. 7.

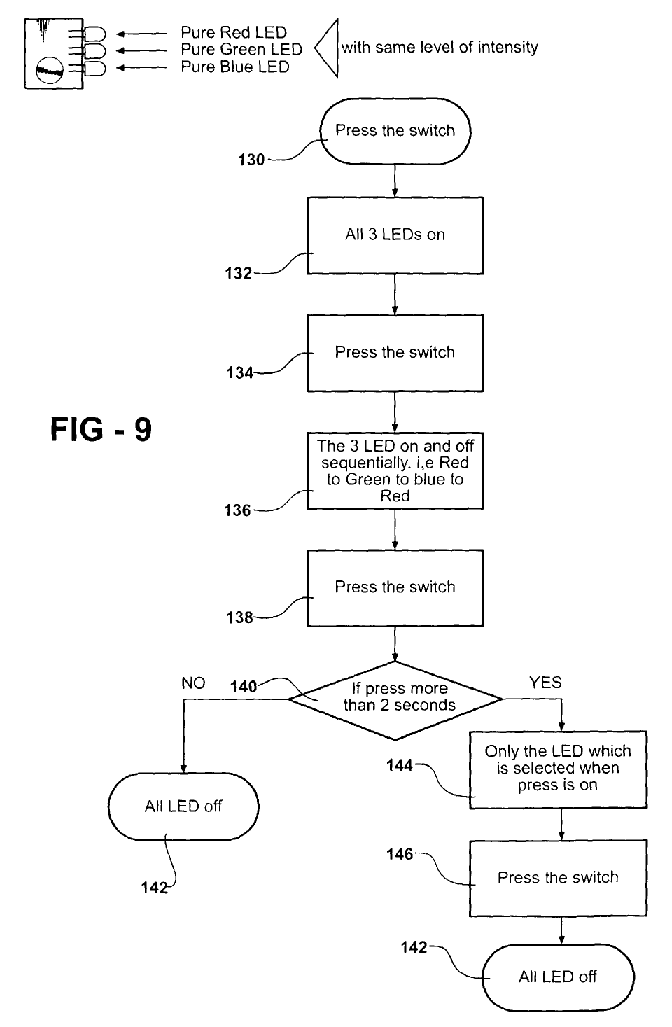

Another operating mode for an inventive device having multiple pure color LEDs is shown in FIG. 9 for the exemplary situation of three LEDs, being present with a pure red LED, pure green LED, and pure blue LED being present. Initial activation of the inventive device switch 130 causes illumination of all the LEDs. Subsequent activation of the inventive device switch 134 causes sequential emission from each of the LEDs with the other LEDs in an inactive state 136. Thereafter, activation of the inventive device switch 138 for less than a preselected amount of time 140 deactivates all of the LEDs 142. Activating the switch 138 for more than a preselected amount of time 140 causes one of the three LEDs to emit continuously while the other LEDs are deactivated 144. Subsequent activation of the inventive device switch 146 ceases emission from all LEDs 142.

While various play patterns for an inventive device have been detailed herein, it is appreciated that each individual LED is readily replaced by a bank of similar LEDs. Further, it is appreciated that the sequence of inventive device emission modes within a given play pattern are readily modified within a given play pattern. As a result, one skilled in the art will readily appreciate that for each LED present within an inventive device the emission is readily controlled with respect to intensity, continuous or periodic emission, and in the case of a variable emission color LED, also the emissive color.

The foregoing description is illustrative of particular embodiments of the invention, but is not meant to be a limitation upon the practice thereof. The following claims, including all equivalents thereof, are intended to define the scope of the invention.

1. A computer peripheral comprising:
a peripheral housing having a translucent or transparent region;
a light source within said housing positioned to emit light through the translucent or transparent region;
a wire in electrical communication with said light source; and
a computer interface connector in electrical communication with said wire and adapted to couple to a computer.

2. The computer peripheral of claim 1 wherein said computer interface connector is a universal scrial bus.

3. The computer peripheral of claim 1 wherein said light source is a light emitting diode.

4. The computer peripheral of claim 1 wherein said light source is a plurality of light emitting diodes.

5. The computer peripheral of claim 4 wherein at least two of said plurality of light emitting diodes differ in emission color.

6. The computer peripheral of claim 5 wherein each of said plurality of LEDs independently has a color selected from the group consisting of: red, orange, yellow, green, blue, violet, red-green-blue and white.

7. The computer peripheral of claim 1 further comprising an electrical regulation subcircuit intermediate between said wire and said light source.

8. The computer peripheral of claim 7 wherein said regulation subcircuit modulates illumination of said light source.

9. The computer peripheral of claim 7 wherein said computer interface connector is a universal serial bus and said light source is a plurality of light emitting diodes.

10. The computer peripheral of claim 9 wherein at least two of said plurality of light emitting diodes differ in color and the net color emission from said plurality of light emitting diodes varies with time.

11. The computer peripheral of claim 1 wherein said peripheral housing is a mouse housing.

12. The computer peripheral of claim 1 wherein said peripheral housing is a computer light.

13. The computer peripheral of claim 12 further comprising a securement and a lamp body wherein said securement couples to said lamp body and said securement is adapted to engage a portable electronic device.

14. The computer peripheral of claim 13 wherein said wire is capable of electrical communication with a port of the portable electronic device while said wire is partly located within said housing.

15. The computer peripheral of claim 13 wherein said light source is a plurality of light emitting diodes wherein an emission characteristic of each light emitting diode of said plurality of light emitting diodes is varied as a function of time wherein the emission characteristic is selected from the group consisting of: intensity, color, and illumination continuity.

16. The computer peripheral of claim 1 wherein said peripheral housing is a speaker housing.

17. The computer peripheral of claim 1 wherein said peripheral housing is a display frame housing.

18. The computer peripheral of claim 1 wherein said peripheral housing is a disc housing.

19. A computer peripheral comprising:
a housing having a translucent or transparent portion;
a plurality of light emitting diodes directed to project light emitting diode emissions through said translucent housing portion;
a regulation subcircuit driving said plurality of light emitting diodes;
a wire in electrical communication with said regulation subcircuit; and
a universal serial bus connector in electrical communication with said wire.

20. The computer peripheral of claim 19 wherein at least two of said plurality of light emitting diodes differ in emission color.

21. The computer peripheral of claim 19 wherein each of said plurality of LEDs independently has a color selected from the group consisting of: red, orange, yellow, green, blue, violet, red-green-blue and white.

22. The computer peripheral of claim 19 wherein said regulation subcircuit modulates illumination of said light source.

23. The computer peripheral of claim 19 wherein at least two of said plurality of light emitting diodes differ in color and the net color emission from said plurality of light emitting diodes varies with time.

24. The computer peripheral of claim 19 wherein said peripheral housing is a mouse housing.

25. The computer peripheral of claim 19 wherein said peripheral housing is a computer light.

26. The computer peripheral of claim 25 further comprising a securement and a lamp body wherein said securement couples to said lamp body and said securement is adapted to engage a portable electronic device.

27. The computer peripheral of claim 26 wherein said wire is capable of electrical communication with a port of the portable electronic device while said wire is partly located within said housing.

28. The computer peripheral of claim 26 wherein said light source is a plurality of light emitting diodes wherein an emission characteristic of each light emitting diode of said plurality of light emitting diodes is varied as a function of time wherein the emission characteristic is selected from the group consisting of: intensity, color, and illumination continuity.

29. The computer peripheral of claim 19 wherein said peripheral housing is a speaker housing.

30. The computer peripheral of claim 19 wherein said peripheral housing is a display frame housing.

31. The computer peripheral of claim 19 wherein said peripheral housing is a disc housing.
